(19) United States
(12) Patent Application Publication
(10) Pub. No.: US 2023/0184612 A1
(43) Pub. Date: Jun. 15, 2023

(54) RADIAL FAULT SIMULATION TEST SYSTEM FOR ROTARY MECHANICAL EQUIPMENT

(71) Applicant: CHN ENERGY DADU RIVER REPAIR & INSTALLATION CO., LTD., Chengdu, Sichuan (CN)

(72) Inventors: Qiang DING, Chengdu, Sichuan (CN); Enzhong WANG, Chengdu, Sichuan (CN); Lei SU, Chengdu, Sichuan (CN); Zhiguo FENG, Chengdu, Sichuan (CN); Yinkang RAN, Chengdu, Sichuan (CN); Yinhui CAI, Chengdu, Sichuan (CN); Tao YANG, Chengdu, Sichuan (CN); Xiaofei LI, Chengdu, Sichuan (CN); Yu ZHANG, Chengdu, Sichuan (CN); Changyun SHUAI, Chengdu, Sichuan (CN); Hongtao SHEN, Chengdu, Sichuan (CN)

(21) Appl. No.: 17/765,944

(22) PCT Filed: Sep. 30, 2021
(86) PCT No.: PCT/CN2021/122027

§ 371 Date: Apr. 1, 2022

(30) Foreign Application Priority Data
Oct. 15, 2020 (CN) 202011100930.6

(51) Int. Cl. G01M 1/22; G01M 13/045; G01H 1/00

(52) U.S. Cl. CPC G01M 1/22; G01H 1/003; G01M 13/045

(57) ABSTRACT

Disclosed is a radial fault simulation test system for rotary mechanical equipment. The system comprises a simulation test bed, a data collection system and a control system, wherein the data collection system is used for collecting the operation state data of a rotating shaft; and the control system is used for receiving the data collected by the data collection system, analyzing and processing the data, and controlling the simulation test bed according to an analysis result. The system adopts a modular design, can simulate the operation state and the fault type of the rotary mechanical system under different rotation conditions and structural forms, can realize a simulation test of the rotary mechanical system under different fault states, and can preferably ensure the accuracy of the test performance of the simulation test.

### TECHNICAL FIELD

The present disclosure relates to the technical field of rotary mechanical fault testing, in particular to a radial fault simulation test system for rotary mechanical equipment.

### BACKGROUND ART

Rotary mechanical equipment can be seen everywhere in our daily life and is widely applied, and the fault problem of the rotary mechanical equipment is always paid attention to people. Rotary mechanical faults may affect the product quality, or even cause production halt to affect the whole production process, so that accurate simulation test on radial faults of the rotary machinery equipment is of great significance to research on the radial faults of the rotary machinery equipment, and how to ensure the accuracy and authenticity of simulation test data and ensure the universality of a test system is a main problem faced at present.

### SUMMARY

Aiming at the technical problems in the prior art, the present disclosure provides a radial fault simulation test system for rotary mechanical equipment.

In order to solve the technical problem, a technical solution adopted by the present disclosure is as follows:

A radial fault simulation test system for rotary mechanical equipment comprises:
a simulation test bed, wherein the simulation test bed comprises a variable frequency motor, a motor position adjusting piece, a main shaft, diaphragm couplings, sliding bearing seats, sliding bearings, bearing position adjusting pieces, a radial loader, a brake, a balance disc, an additional mass block and a platform base, the motor position adjusting piece, the bearing position adjusting pieces, the radial loader and the brake are arranged on the platform base, the variable frequency motor is arranged on the motor position adjusting piece, the motor position adjusting piece can adjust the position of the variable frequency motor along the transverse or longitudinal direction in the horizontal direction, the sliding bearing seat is arranged on the bearing position adjusting piece, the bearing position adjusting piece can adjust the position of the sliding bearing seat along the transverse or longitudinal direction in the horizontal direction, the sliding bearing is arranged on the sliding bearing seat, the main shaft is arranged on the sliding bearing seat through the sliding bearing, one end of the main shaft is connected with the variable frequency motor through the diaphragm coupling, the other end of the main shaft is connected with the brake through the diaphragm coupling, the balance disc is arranged on the main shaft, and the radial loader is arranged between the two sliding bearing seats and used for applying radial acting force to the main shaft;
a data collection system, wherein the data collection system is used for collecting the operation state data of a rotating shaft; the data collection system comprises a multi-channel data collection unit, a rotating speed detection system for detecting the rotating speed of the main shaft and a displacement sensor assembly for testing the displacement of the rotating shaft in the X direction and the Y direction, the rotating speed detection system, the displacement sensor assembly and the rotating speed detection system are respectively connected with the multi-channel data collection unit, and the collected signals are transmitted to the multi-channel data collection unit; the rotating speed detection system is arranged at the end of a rotating shaft of the brake and comprises a first base layer arranged on the rotating shaft, a dielectric layer arranged on the first base layer, a base arranged outside the rotating shaft in a sleeving mode, a second base layer arranged in the base and an electrode arranged on the second base layer, the electrode and the dielectric layer are oppositely arranged, the first base layer and the second base layer are organic glass substrates, the dielectric layer is preferably made of polytetrafluoroethylene, and the electrode is preferably made of a copper sheet; the electrode is connected to the multi-channel data collection unit, and the multi-channel data collection unit analyzes the rotating speed of the rotating shaft according to a received potential signal; and
a control system, wherein the control system is used for receiving the data collected by the data collection system, analyzing and processing the data, and controlling the simulation test bed according to an analysis result.

As further improvement of the technical solution, the sliding bearing comprises circular or oval bearing bushes, the bearing bushes comprise an upper bearing bush and a lower bearing bush which are oppositely arranged, a groove is formed in the bottom of the lower bearing bush, horizontally arranged along the axial direction of the lower bearing bush and symmetrically arranged relative to the center of the lower bearing bush, the length of the groove is ½-⅔ of the length of the lower bearing bush, the included angles between the two sides of the groove in the width direction and the center of the sliding bearing are 90°, and the depth of the groove is 0.2-0.5 mm; the upper bearing bush and the lower bearing bush are both of a combined structure, the upper bearing bush and the lower bearing bush each comprise a bearing bush initial section, a bearing bush end filling section and/or at least one bearing bush middle filling section, and the bearing bush middle filling section is arranged between the bearing bush initial section and the bearing bush end filling section in a matched mode.

As further improvement of the technical solution, the matched connecting positioning structures are arranged among the bearing bush initial section, the bearing bush end filling section and the bearing bush middle filling section, the bearing bush initial section, the bearing bush end filling section and the bearing bush middle filling section are connected through the connecting positioning structures, the connecting positioning structures comprise a limiting groove arranged at one end of the bearing bush initial section, a connecting clamping piece arranged at one end of the bearing bush end filling section, and a limiting groove and a connecting clamping piece arranged at two ends of the bearing bush middle filling section, the limiting grooves are oppositely formed in the inner side and the outer side of the bearing bush, the connecting clamping pieces comprise two clamping pieces which are oppositely arranged, and the clamping pieces can be correspondingly arranged in the limiting grooves in a matched mode.

The present disclosure has the following beneficial effects:

Firstly, the system adopts a modular design, can simulate the operation state and the fault type of the rotary mechanical system under different rotation conditions and structural forms, can realize a simulation test of the rotary mechanical system under different fault states, and can preferably ensure the accuracy of the test performance of the simulation test.

Secondly, a groove structure is formed on the bearing bush of the sliding bearing of the system, and the specific pressure between the shaft neck of the main shaft and the bearing bush is increased, so that the relative eccentricity of the shaft neck in the bearing bush is increased; and the bearing bush is of a combined structure, so that the operation stability of the simulation test bed can be effectively improved, the accuracy of the test data of the system is ensured, and a reliable reference is provided for testing and judging faults of the rotary mechanical equipment.

Thirdly, the rotating speed detection system in the system is based on the triboelectric principle, the rotating speed of the rotating shaft can be accurately monitored, meanwhile, the operation state of the rotating shaft can be monitored, and the overall cost of the system can be effectively reduced; and the device is simple and convenient to set on the rotary mechanical system, and can be widely applied to monitoring of the rotary mechanical equipment.

### BRIEF DESCRIPTION OF THE DRAWINGS

FIG. 1 is a structural schematic diagram of a simulation test bed in the present disclosure;

FIG. 2 is a structural front view of a simulation test bed in the present disclosure;

FIG. 3 is a structural schematic diagram of a rotating speed detection system in the present disclosure;

FIG. 4 is a cross section schematic diagram of a groove in a bearing bush in the present disclosure;

FIG. 5A is a combined structural schematic diagram of a bearing bush in the present disclosure;

FIG. 5B is a structural right side view of a bearing bush initial section in the present disclosure; and

FIG. 5C is a structural left side view of a bearing bush middle filling section in the present disclosure.

Reference signs: 1, variable frequency motor; 2, motor position adjusting piece; 3, main shaft; 4, diaphragm coupling; 5, sliding bearing seat; 6, sliding bearing; 7, bearing position adjusting piece; 8, radial loader; 9, brake; 10, balance disc; 11, additional mass block; 12, platform base;

601, lower bearing bush; 602, groove; 603, bearing bush initial section; 604, bearing bush end filling section; 605, bearing bush middle filling section; 606, connecting clamping piece; 706, limiting groove;

901, rotating shaft;

13, sensor support; 14, base;

14a, first base layer; 14b, dielectric layer; 14c, second base layer; and 14d, electrode.

### DETAILED DESCRIPTION OF THE EMBODIMENTS

The present disclosure is further described in conjunction with the attached figures and specific embodiments.

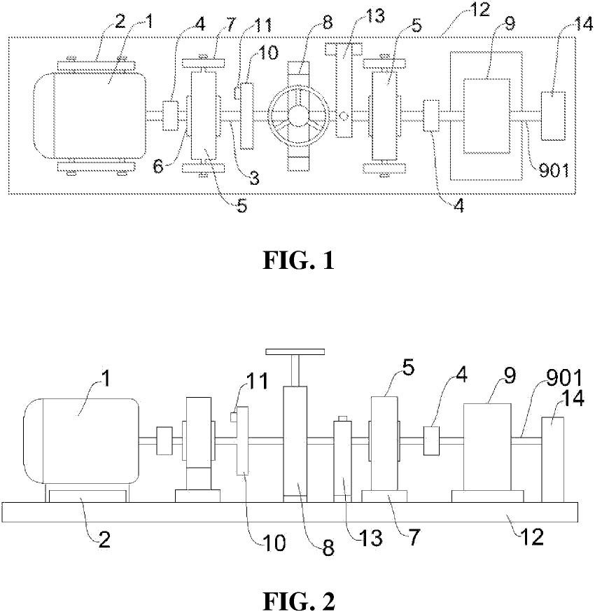

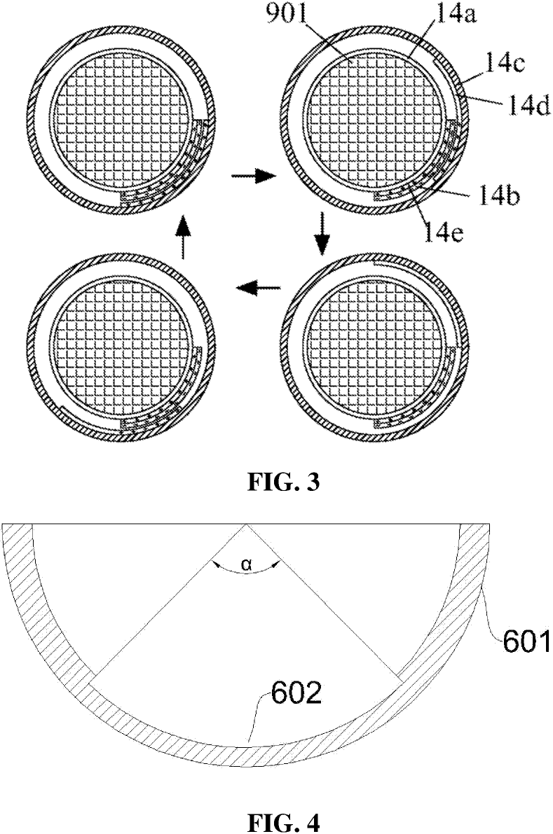

As shown in FIG. 1 and FIG. 2, a radial fault simulation test system for rotary mechanical equipment comprises:

a simulation test bed, wherein the simulation test bed is used for simulating the movement of a shaft under various working conditions, and comprises a variable frequency motor 1, a motor position adjusting piece 2, a main shaft 3, diaphragm couplings 4, sliding bearing seats 5, sliding bearings 6, bearing position adjusting pieces 7, a radial loader 8, a brake 9, a balance disc 10, an additional mass block 11 and a platform base 12, the motor position adjusting piece 2, the bearing position adjusting pieces 7, the radial loader 8 and the brake 9 are arranged on the platform base 12, the variable frequency motor 1 is arranged on the motor position adjusting piece 2, the motor position adjusting piece 2 can adjust the position of the variable frequency motor along the transverse or longitudinal direction in the horizontal direction, the sliding bearing seat 5 is arranged on the bearing position adjusting piece 7, the bearing position adjusting piece 7 can adjust the position of the sliding bearing seat along the transverse or longitudinal direction in the horizontal direction, the sliding bearing 6 is arranged on the sliding bearing seat 5, the main shaft 3 is arranged on the sliding bearing seat 5 through the sliding bearing, one end of the main shaft 3 is connected with the variable frequency motor 1 through the diaphragm coupling 4, the other end of the main shaft 3 is connected with a rotating shaft 901 of the brake 9 through the diaphragm coupling 4, the balance disc 10 is arranged on the main shaft 3, and the radial loader 8 is arranged between the two sliding bearing seats 5 and used for applying radial acting force to the main shaft;

The motor position adjusting piece 2 and the bearing position adjusting pieces 7 are arranged on the platform base 12, position adjusting screws are installed at the two ends of the motor position adjusting piece 2 and the bearing position adjusting pieces 7, and the positions of the variable frequency motor and the sliding bearing seats on the platform base can be adjusted by adjusting the position adjusting screws.

The diaphragm coupling 4 in the embodiment can be used for connection between a motor and a transmission shaft in a high-precision occasion, can be used for a non-centering and eccentric occasion generated in a radial loading process, has an elastic effect, and can compensate radial, angular and axial deviations.

The balance disc 10 can be rapidly detached and moved and adjusted, the diameter is 140 mm, the thickness is 25 mm, 20 hole positions are evenly distributed in the circumference of the balance disc, unbalanced loading can be conducted on the two faces, and the balance disc 10 is made of 45 steel. The additional mass block 11 is arranged on the balance disc 10 and can simulate the working condition of the rotor under an unbalanced fault, and the weight and the position of the additional mass block on the balance disc can be adjusted according to needs so as to simulate different unbalanced fault working conditions.

The brake 9 is an HZ-6J/Q type brake, the rated torque is 6N·M, the highest rotating speed is 15000 rpm, the brake 9 is in a short-time working mode and a continuous working mode, the power of the short-time mode is 2300 W every 5 min, the continuous working mode is 2000 W, and the torque tolerance is 0.2%. In the test process, the torque of the brake is adjusted to simulate the output load, so that the actual working scene can be better simulated; when the rotating speed needs to be reduced, the main shaft can be rapidly braked, the speed of the main shaft is reduced or the main shaft is braked, and the sliding bearings are prevented from being abraded under the low-rotating-speed working condition; and when the simulation test bed of the test system fails, the test bed can be rapidly braked, so that accidents are prevented.

The radial loader 8 is in a threaded manual loading or hydraulic driving loading mode, and is provided with a corresponding sensor for displaying the loaded acting force.

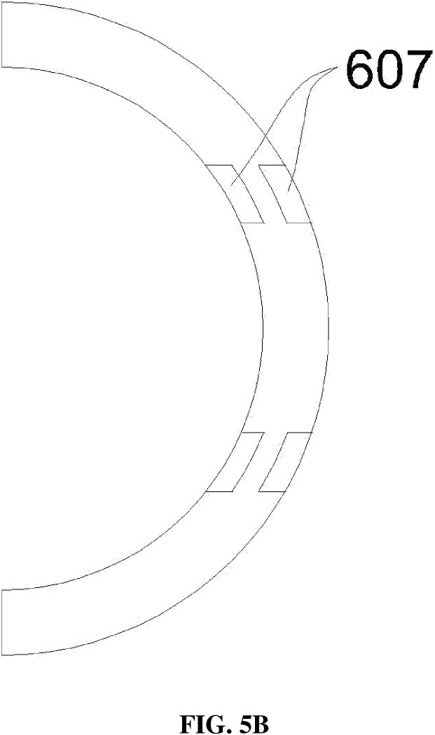

The sliding bearing 6 in the embodiment comprises circular or oval bearing bushes, the bearing bushes comprise an upper bearing bush and a lower bearing bush 601 which are oppositely arranged, a groove 602 is formed in the bottom of the lower bearing bush 601, as shown in FIG. 4, the groove 602 is horizontally arranged along the axial direction of the lower bearing bush and symmetrically arranged relative to the center of the lower bearing bush, and the length of the groove is ½-⅔ of the length of the lower bearing bush, preferably ⅔ of the length of the lower bearing bush; the included angles between the two sides of the groove 602 in the width direction and the center of the sliding bearing are 90°, and the depth of the groove 602 is 0.2-0.5 mm. A groove structure is formed in the bottom of the bearing bush, size parameters of the groove are optimized, the specific pressure between the shaft neck of the main shaft and the bearing bush can be greatly increased by 15%-20%, the relative eccentricity of the shaft neck in the bearing bush can be remarkably increased by increasing the specific pressure, and therefore the operation stability of a rotor bearing system is guaranteed, the stability of the main shaft during operation is ensured, and the collected data are more accurate.

The upper bearing bush and the lower bearing bush in the embodiment are both of a combined structure, the upper bearing bush and the lower bearing bush each comprise a bearing bush initial section 603, a bearing bush end filling section 604 and/or at least one bearing bush middle filling section 605, and the bearing bush middle filling section 605 is arranged between the bearing bush initial section 603 and the bearing bush end filling section 604 in a matched mode. The bearing bush is of a combined structure, and the length of the bearing bush can be adjusted, so that the specific pressure is changed, an oil film resonance area is effectively avoided, and the stability in the system operation process and the reliability of a simulation test result are ensured. In the lower bearing bush of the combined structure, grooves can be respectively formed in the bottom of each section of the lower bearing bush, grooves can be formed in the bearing bush initial section and the bearing bush end filling section, or a groove is only formed in the bearing bush initial section.

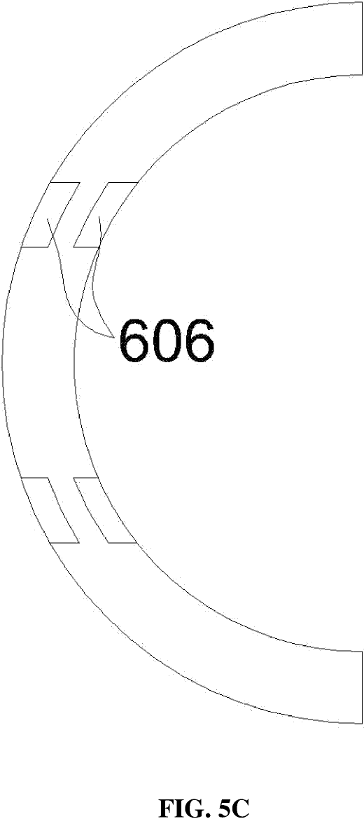

Preferably, as shown in FIG. 5 (specifically FIG. 5A, FIG. 5B and FIG. 5C), matched connecting positioning structures are arranged among the bearing bush initial section 603, the bearing bush end filling section 604 and the bearing bush middle filling section 605, and the bearing bush initial section 603, the bearing bush end filling section 604 and the bearing bush middle filling section 605 are connected through the connecting positioning structures. The connecting positioning structures comprise a limiting groove 607 arranged at one end of the bearing bush initial section, a connecting clamping piece 606 arranged at one end of the bearing bush end filling section, and a limiting groove 607 and a connecting clamping piece 606 arranged at two ends of the bearing bush middle filling section, the limiting grooves 607 are oppositely formed in the inner side and the outer side of the bearing bush, the connecting clamping pieces 606 comprise two clamping pieces which are oppositely arranged, and the clamping pieces can be correspondingly arranged in the limiting grooves 607 in a matched mode. Connecting holes are correspondingly formed in the connecting clamping piece and the limiting groove, and connecting pins are correspondingly arranged in the connecting holes to fixedly connect the bearing bush initial section, the bearing bush end filling section and the bearing bush middle filling section; a rubber mat is arranged between the connecting clamping piece and the limiting groove, the gap between the connecting clamping piece and the limiting groove is filled, and the stability of connection between all sections of bearing bushes can be effectively guaranteed.

The data collection system in the embodiment is used for collecting the operation state data of the rotating shaft; the data collection system comprises a multi-channel data collection unit, a rotating speed detection system for detecting the rotating speed of the main shaft and a displacement sensor assembly for testing the displacement of the rotating shaft in the X direction and the Y direction, the rotating speed detection system, the displacement sensor assembly and the rotating speed detection system are respectively connected with the multi-channel data collection unit, and the collected signals are transmitted to the multi-channel data collection unit.

An input channel of the multi-channel data collection unit comprises 16 AIs (built-in anti-aliasing filters) and two channels DI, the types of the input channels comprise various data inputs such as acceleration, speed, displacement, voltage, current, pressure, temperature, keys and the like, and it is guaranteed that signals of various sensors can be received at the same time.

As shown in FIG. 1, the displacement sensor assembly is arranged at the corresponding position of the main shaft 3 through a sensor support 13.

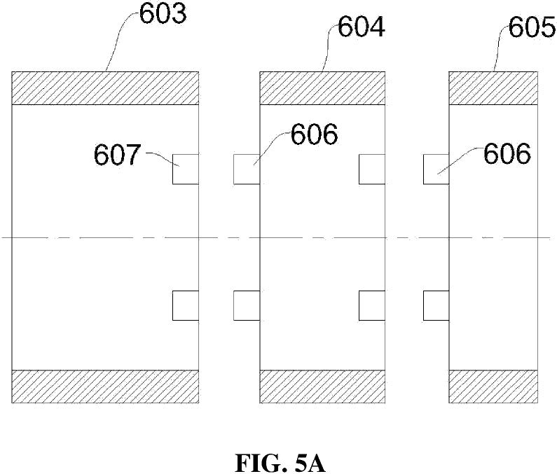

As shown in FIG. 3, the rotating speed detection system is arranged at the end of the rotating shaft of the brake and comprises a first base layer 14a arranged on the rotating shaft 901, a dielectric layer 14b arranged on the first base layer, a base 14 arranged outside the rotating shaft in a sleeving mode, a second base layer 14c arranged in the base and an electrode 14d arranged on the second base layer, the electrode 14d and the dielectric layer 14b are oppositely arranged, the first base layer 14a and the second base layer 14c are organic glass substrates, the dielectric layer 14b is made of polytetrafluoroethylene or other materials with the same function, and the electrode 14d is made of a copper sheet or other materials with the same function. Here, the dielectric layer 14b can be embedded into the first base layer 14a, and is flush with the outer surface of the first base layer 14a; the electrode 14d can be embedded into the second base layer 14c and is flush with the inner surface of the second base layer 14c, the dielectric layer and the electrode are stably limited, meanwhile, the dielectric layer and the electrode are effectively protected, and the stability and reliability of data collection of the rotating speed detection system are guaranteed. Preferably, the lengths of the dielectric layer and the electrode in the circumferential direction are ¼ of the perimeters of the first base layer and the second base layer respectively, and the accuracy of system test data is guaranteed.

The electrode of the rotating speed detection system is connected to the multi-channel data collection unit, and the multi-channel data collection unit analyzes the rotating speed of the rotating shaft according to a received potential signal. When the rotating shaft rotates, the first base layer and the dielectric layer are driven to rotate, when the dielectric layer and the electrode are overlapped, induced charges are generated, the larger the overlapped area is, the larger the potential of the generated induced charges is, and when the dielectric layer and the electrode are completely separated, the charges disappear; and in the process, the electrode generates periodically changing potential due to rotation of the main shaft, and the rotating speed of the rotating shaft can be measured by analyzing the potential change. Compared with an existing rotating speed sensor, the rotating speed detection system is simple in structure, convenient to set in the test system and capable of being set at each position where the rotating speed needs to be tested according to needs, contact friction does not exist between a rotating part and a fixed part, and the rotating speed detection system is high in durability and long in service life. Meanwhile, the rotating speed detection system can detect and feed back the rotating condition of the rotating shaft, when the rotating shaft vibrates, the periodic change of the potential is affected, the change rule of the potential in each period fluctuates to a certain degree, and therefore the vibration condition of the rotating shaft is judged and detected by observing the fluctuation condition of the periodic potential.

The control system is used for receiving the data collected by the data collection system, analyzing and processing the data, and controlling the simulation test bed according to an analysis result.

The radial fault simulation test system for rotary mechanical equipment in the embodiment can be used for simulation test of the rotary mechanical equipment under an unbalanced working condition, simulation test of the rotary mechanical equipment under a non-centering fault working condition, simulation test of the rotary mechanical equipment under a shaft eccentric fault working condition and simulation test of the rotary mechanical equipment under a shaft system radial loading working condition; and based on the radial fault simulation test system for rotary mechanical equipment, the simulation test method under various working conditions is specifically as follows:
simulation test under the unbalanced working condition comprises the following specific steps:
   A1, installing a main shaft to be tested on a simulation test bed, installing a balance disc on the main shaft, and installing an additional mass block at a corresponding position on the balance disc;
   A2, adjusting the torque of a brake, adjusting a test condition to an actual working condition state, and setting a displacement sensor assembly and a rotating speed measuring system;
   A3, controlling a variable frequency motor to be adjusted to an initial test rotating speed, and recording parameters such as displacement and rotating speed of the main shaft and voltage and current of the variable frequency motor;
   A4, adjusting the rotating speed of the variable frequency motor to the next test rotating speed, and recording corresponding parameters;
   A5, adjusting the balance disc and the additional mass block, and repeating the steps A3 to A4; and
   A6, controlling the variable frequency motor to be shut down, reducing the rotating speed to 10% of the rated rotating speed, starting a brake, and braking the system to finish the test.
simulation test under the non-centering fault working condition comprises the following specific steps:
   B1, installing a main shaft to be tested on a simulation test bed;
   B2, adjusting the torque of a brake, adjusting a test condition to an actual working condition state, and setting a displacement sensor assembly and a rotating speed measuring system;
   B3, adjusting a motor position adjusting piece, so that a variable frequency motor and the main shaft are not centered, and a certain non-centering amount is set;
   B4, controlling the variable frequency motor to be adjusted to an initial test rotating speed, and recording parameters such as displacement and rotating speed of the main shaft and voltage and current of the variable frequency motor;
   B5, adjusting the rotating speed of the variable frequency motor to the next test rotating speed, and recording corresponding parameters;
   B6, adjusting the motor position adjusting piece, setting another non-centering amount between the variable frequency motor and the main shaft, and repeating the steps B4 to B5; and
   B7, controlling the variable frequency motor to be shut down, reducing the rotating speed to 10% of the rated rotating speed, starting a brake, and braking the system to finish the test.
simulation test under the shaft eccentric fault working condition:
   C1, prefabricating a fault eccentric shaft, and installing a main shaft to be tested on a simulation test bed;
   C2, adjusting the torque of a brake, adjusting a test condition to an actual working condition state, and setting a displacement sensor assembly and a rotating speed measuring system;
   C3, controlling the variable frequency motor to be adjusted to an initial test rotating speed, and recording parameters such as displacement and rotating speed of the main shaft and voltage and current of the variable frequency motor;
   C4, adjusting the rotating speed of the variable frequency motor to the next test rotating speed, and recording corresponding parameters;
   C5, replacing another fault eccentric shaft, and repeating the steps C3 to C4; and
   C6, controlling the variable frequency motor to be shut down, reducing the rotating speed to 10% of the rated rotating speed, starting a brake, and braking the system to finish the test.
simulation test under the shaft system radial loading working condition:
   D1, prefabricating a fault eccentric shaft, and installing a main shaft to be tested on a simulation test bed;
   D2, adjusting the torque of a brake, adjusting a test condition to an actual working condition state, and setting a displacement sensor assembly and a rotating speed measuring system;
   D3, controlling the variable frequency motor to be adjusted to an initial test rotating speed, and recording parameters such as displacement and rotating speed of the main shaft and voltage and current of the variable frequency motor;
   D4, adjusting the rotating speed of the variable frequency motor to the next test rotating speed, and recording corresponding parameters;
   D5, replacing another fault eccentric shaft, and repeating the steps D3 to D4; and
   D6, controlling the variable frequency motor to be shut down, reducing the rotating speed to 10% of the rated rotating speed, starting a brake, and braking the system to finish the test.

The description and the attached figures of the present disclosure are regarded as illustrative and not restrictive, and on the basis of the present disclosure, those skilled in the art can make some substitutions and modifications to some of the technical features without inventive labor according to the disclosed technical content, which are within the scope of protection of the present disclosure.

What is claimed is:

1. A radial fault simulation test system for rotary mechanical equipment, comprising:
a simulation test bed, wherein the simulation test bed comprises a variable frequency motor, a motor position adjusting piece, a main shaft, diaphragm couplings, sliding bearing seats, sliding bearings, bearing position adjusting pieces, a radial loader, a brake, a balance disc, an additional mass block and a platform base, the motor position adjusting piece, the bearing position adjusting pieces, the radial loader and the brake are arranged on the platform base, the variable frequency motor is arranged on the motor position adjusting piece, the motor position adjusting piece can adjust the position of the variable frequency motor along the transverse or longitudinal direction in the horizontal direction, the sliding bearing seat is arranged on the bearing position adjusting piece, the bearing position adjusting piece can adjust the position of the sliding bearing seat along the transverse or longitudinal direction in the horizontal direction, the sliding bearing is arranged on the sliding bearing seat, the main shaft is arranged on the sliding bearing seat through the sliding bearing, one end of the main shaft is connected with the variable frequency motor through the diaphragm coupling, the other end of the main shaft is connected with the brake through the diaphragm coupling, the balance disc is arranged on the main shaft, and the radial loader is arranged between the two sliding bearing seats and used for applying radial acting force to the main shaft;
a data collection system, wherein the data collection system is used for collecting the operation state data of a rotating shaft; the data collection system comprises a multi-channel data collection unit, a rotating speed detection system for detecting the rotating speed of the main shaft and a displacement sensor assembly for testing the displacement of the rotating shaft in the X direction and the Y direction, the rotating speed detection system, the displacement sensor assembly and the rotating speed detection system are respectively connected with the multi-channel data collection unit, and the collected signals are transmitted to the multi-channel data collection unit; the rotating speed detection system is arranged at the end of a rotating shaft of the brake and comprises a first base layer arranged on the rotating shaft, a dielectric layer arranged on the first base layer, a base arranged outside the rotating shaft in a sleeving mode, a second base layer arranged in the base and an electrode arranged on the second base layer, the electrode and the dielectric layer are oppositely arranged, the first base layer and the second base layer are organic glass substrates, the dielectric layer is preferably made of polytetrafluoroethylene, and the electrode is preferably made of a copper sheet; the electrode is connected to the multi-channel data collection unit, and the multi-channel data collection unit analyzes the rotating speed of the rotating shaft according to a received potential signal; and
a control system, wherein the control system is used for receiving the data collected by the data collection system, analyzing and processing the data, and controlling the simulation test bed according to an analysis result.

2. The radial fault simulation test system for rotary mechanical equipment according to claim 1, wherein the sliding bearing comprises circular or oval bearing bushes, the bearing bushes comprise an upper bearing bush and a lower bearing bush which are oppositely arranged, a groove is formed in the bottom of the lower bearing bush, horizontally arranged along the axial direction of the lower bearing bush and symmetrically arranged relative to the center of the lower bearing bush, the length of the groove is ½-⅔ of the length of the lower bearing bush, the included angles between the two sides of the groove in the width direction and the center of the sliding bearing are 90°, and the depth of the groove is 0.2-0.5 mm; the upper bearing bush and the lower bearing bush are both of a combined structure, the upper bearing bush and the lower bearing bush each comprise a bearing bush initial section, a bearing bush end filling section and/or at least one bearing bush middle filling section, and the bearing bush middle filling section is arranged between the bearing bush initial section and the bearing bush end filling section in a matched mode.

3. The radial fault simulation test system for rotary mechanical equipment according to claim 2, wherein the matched connecting positioning structures are arranged among the bearing bush initial section, the bearing bush end filling section and the bearing bush middle filling section, the bearing bush initial section, the bearing bush end filling section and the bearing bush middle filling section are connected through the connecting positioning structures, the connecting positioning structures comprise a limiting groove arranged at one end of the bearing bush initial section, a connecting clamping piece arranged at one end of the bearing bush end filling section, and a limiting groove and a connecting clamping piece arranged at two ends of the bearing bush middle filling section, the limiting grooves are oppositely formed in the inner side and the outer side of the bearing bush, the connecting clamping pieces comprise two clamping pieces which are oppositely arranged, and the clamping pieces can be correspondingly arranged in the limiting grooves in a matched mode.
